(19) United States
(12) Patent Application Publication
(10) Pub. No.: US 2013/0260893 A1
(43) Pub. Date: Oct. 3, 2013

(54) SYSTEM AND METHOD FOR PROVIDING AVATAR/GAME/ENTERTAINMENT FUNCTIONS ON MESSENGER PLATFORM

(71) Applicant: NHN CORPORATION, Seongnam-si (KR)

(72) Inventors: JungHo SHIN, Seongnam-si (KR); Jungmin LEE, Seongnam-si (KR); Hyun Joo NA, Seongnam-si (KR)

(73) Assignee: NHN Corporation, Seongnam-si (KR)

(21) Appl. No.: 13/730,124

(22) Filed: Dec. 28, 2012

(30) Foreign Application Priority Data
Mar. 30, 2012 (KR) 10-2012-0032878
Jun. 12, 2012 (KR) 10-2012-0062521

(51) Int. Cl. G06F 3/0481

(52) U.S. Cl. CPC G06F 3/04815
USPC 463/42; 715/757

(57) ABSTRACT

Provided is a system and method for providing avatar, gaming and entertainment functions on a messenger platform. A method for providing a messenger service using a real graph displaying social information of users using a messenger may include: providing a messenger function among users between whom a relationship is established; providing a first user interface for providing a virtual world service through the messenger function; providing the virtual world service using a virtual graph displaying social information of users using the virtual world service; converting the real world service, to the virtual world service in response to a request from the first user interface, and providing a second interface for converting the virtual world service to the real world service. The virtual world service may include at least one of an avatar service and a game service.

### CROSS-REFERENCE TO RELATED APPLICATIONS

This application claims priority from and the benefit of Korean Patent Application No. 10-2012-0032878, filed on Mar. 30, 2012, and Korean Patent Application No. 10-2012-0062521, filed on Jun. 12, 2012, which are hereby incorporated by reference for all purposes as if fully set forth herein.

### BACKGROUND OF THE INVENTION

1. Field of the Invention

Exemplary embodiments of the present invention relate to a system and method for providing avatar, gaming and entertainment features on a messenger platform.

2. Description of Related Art

A messenger service on a computer exchanges messages and data in real time on the Internet, enabling instant responses to be received from another user. Use of the messenger service is faster than communicating by e-mail since connectivity of a user to the Internet may be verified. The messenger service supports a group chat in addition to a voice chat, and sending of text messages and large volume video files to a mobile phone.

### SUMMARY OF THE INVENTION

Exemplary embodiments of the present invention provide a system and method for providing avatar, gaming and/or entertainment features on a messenger platform.

Exemplary embodiments of the present invention also provide a system and method for providing a real world service such as a messenger service and a virtual world service such as an avatar service or a game service through a messenger platform.

Exemplary embodiments of the present invention also provide a system and method for providing a real world service and a virtual world service by converting a real world based on a real graph displaying social information on a messenger and a virtual world based on a virtual graph.

Exemplary embodiments of the present invention also provide a system and method for recommending a relationship to a user for establishing the relationship in a virtual world using a real graph based on the real world.

Additional features of the invention will be set forth in the description which follows, and in part will be apparent from the description, or may be learned by practice of the invention.

Exemplary embodiments of the present invention disclose a method that uses a processor to perform a messenger service using a real graph displaying social information of users using a messenger, the method including: providing a messenger function to users between whom a relationship is established using the messenger; providing a first user interface for providing a virtual world service through the messenger function; converting, using the processor, a real world messenger service to the virtual world service in response to a request from the first user interface; providing the virtual world service using a virtual graph displaying social information of users using the virtual world service; and providing a second user interface for converting the virtual world service to the real world service through the virtual world service, wherein the virtual world service includes at least one of an avatar service and a game service.

Exemplary embodiments of the present invention disclose a messenger system for providing a messenger service using a real graph displaying social information of users using a messenger, the messenger system including: a processor; a messenger function providing unit configured to provide a messenger function interactively to users between whom a relationship is established among the users; a first user interface configured to provide a virtual world service through the messenger function; a virtual world service providing unit to provide the virtual world service by converting, using the processor, the real world service to the virtual world service, wherein the virtual world service provided using a virtual graph displaying social information of users using the virtual world service in a response to a request from the first user interface; and a second user interface configured to convert the virtual world service to the real world service, through the virtual world service, wherein the virtual world service includes at least one of an avatar service and a game service.

Exemplary embodiments of the present invention disclose a non-transitory computer-readable recording medium including a program for storing instructions for a computer system to provide a messenger service using a real graph displaying social information of users using a messenger, which when executed performs the following steps: providing a messenger function interactively to users between whom a relationship is established; providing a first user interface for providing a virtual world service through the messenger function; converting a real world messenger service to the virtual world service in response to a request from the first user interface; providing the virtual world service using a virtual graph displaying social information of users using the virtual world service; providing a second user interface for converting the virtual world service to the real world service through the virtual world service, and controlling the computer system providing the virtual world service, wherein the virtual world service includes at least one of an avatar service and a game service.

Exemplary embodiments of the present invention disclose a method that uses a processor to perform a messenger service using a real graph displaying social information of users using a messenger, the method including: providing a messenger friends list to a user, or providing a function of chatting with friends with whom the user establishes a relationship, using the real graph; providing a user interface for providing a game service list through the messenger friends list or the function of chatting; providing the game service list in response to a request from the user interface, and playing, using the processor, a game selected from the game service list interactively with a selected chatting friend or with a friend selected from the messenger friends list.

Exemplary embodiments of the present invention disclose a method that uses a processor to perform an interworking service, the method including: providing a real graph displaying social information of users using a messenger service providing a function of chatting; and displaying, using the processor, a virtual graph of social information of users using a game service, wherein the virtual graph is set using information provided by the real graph.

Exemplary embodiments of the present invention disclose a messenger system for providing a messenger service using a real graph displaying social information of users using a messenger, the messenger system including: a messenger function providing unit configured to provide a messenger friends list to a user using the real graph, or to provide a function of chatting with a friend with whom the user establishes a relationship; a first user interface configured to provide a game service list through the messenger friends list or the function of chatting; and a service providing unit configured to provide the game service list in response to a request from the first user interface, and to provide a game selected from the game service list interactively by a user and a chatting friend, or by the user and a friend selected from the messenger friends list.

Exemplary embodiments of the present invention disclose a messenger system including: a real graph providing unit configured to provide a real graph displaying social information of users using a messenger service providing a function of chatting; and a virtual graph providing unit configured to provide a virtual graph displaying social information of users using a game service, wherein the virtual graph is set using the real graph.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 illustrates two panels, a real world panel and a virtual world panel, according to exemplary embodiments of the present invention.

FIG. 2 illustrates conversions between a real world and a virtual world according to exemplary embodiments of the present invention.

FIG. 3 illustrates an avatar menu according to exemplary embodiments of the present invention.

FIG. 4 illustrates an avatar menu according to exemplary embodiments of the present invention.

FIG. 5 illustrates an avatar menu according to exemplary embodiments of the present invention.

FIG. 6 illustrates a method for interacting with a game on a chat screen according to exemplary embodiments of the present invention.

FIG. 7 illustrates a method for interacting with a game on a chat screen according to exemplary embodiments of the present invention.

FIG. 8 illustrates a method for interacting with a game on a chat screen according to exemplary embodiments of the present invention.

FIG. 9 illustrates a method for interacting with a game in a friend listing according to exemplary embodiments of the present invention.

FIG. illustrates a method for interoperating a real graph of a messenger and a virtual graph of a virtual world according to an exemplary embodiment of the present invention.

FIG. 11 illustrates an inner configuration of a messenger system according to exemplary embodiments of the present invention.

FIG. 12 illustrates a method for providing a messenger service according to exemplary embodiments of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements. It should be understood that position and arrangement of individual components in each disclosed exemplary embodiment may be changed without departing from the spirit and the scope of the present invention. Therefore, a detailed description described below should not be construed as being restrictive. The scope of the present invention is defined only by the accompanying claims and their equivalents if appropriate. Similar reference numerals will be used to describe the same or similar functions throughout the accompanying drawing.

It will be understood that for the purposes of this disclosure, “at least one of X, Y, and Z” can be construed as X only, Y only, Z only, or any combination of two or more items X, Y, and Z (e.g., XYZ, XYY, YZ, ZZ).

The terminology used herein is for the purpose of describing exemplary embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising”, when used in this specification, specify the presence of stated features, integers, steps, operations, elements and/or components, but do not preclude the presence or addition of one or more other features, integers, steps, operations, elements, components, and/or groups thereof.

It will be understood that when an element is referred to as being “connected to” another element, it can be directly connected to the other element, or intervening elements may be present.

Exemplary embodiments of the present invention relate to technology of providing users with avatar, game and entertainment features on a messenger platform. A messenger system may provide messaging services on a messenger platform for a real world based on a real graph displaying social information of users on a messenger on the messenger platform interactively associated with a virtual world or a play world based on a virtual graph. The virtual graph may display social information of users in the virtual world provided on the messenger platform. The messenger system may provide the real world on the messenger interactively associated with the virtual world further provided by the messenger platform.

A method for interacting with services may be implemented by the following exemplary embodiments.

A user interface through which a user may enter into each of two worlds divided into a real world based on a graph of the real world relationships of a user (hereinafter “real graph”) and a virtual world graph of the virtual world relationships of a user (hereinafter “virtual graph”) may be provided. When the user selects a corresponding tab, a service may be provided through a screen converted, as a whole, to enter a new world. Converting worlds may be possible using the tab that allows moving to another world, for example, a virtual world, currently unoccupied by the user.

A user interface, for entering into a virtual world may be provided to an action sheet of a chat room provided in a real world. When a user selects a corresponding path a game list and the like, may be displayed, and when the user selects a desired game from the game list, a service of playing the selected game with a counterpart in the chat room may be provided.

When a user selects a counterpart to play a game with from a friends list, and selects a game icon in a user, a game list is provided to the user. When the user selects a game, a service of playing the selected game with the selected counterpart may be provided.

A method for providing a social relationship may be implemented by the following exemplary embodiments. The social relationship may use a real graph displaying an actual social relationship on a messenger by importing the real graph from a virtual graph.

Friend recommendation process: A process for providing a service in which acquaintances active in a virtual world or acquaintances inactive in the virtual world may be displayed on a friends recommendation list using a real graph with whom a user establishes a relationship on a messenger, and the user may make a friend request directly to another user by including the other user in a virtual graph from among the acquaintances displayed on the friends recommendation list.

Process for making friends automatically: A process for providing a service in which acquaintances active in a virtual world with whom a user establishes a relationship on a messenger are automatically set to be acquaintances in the virtual world, a relationship of which is displayed using a virtual graph.

Virtual World or Play World

The virtual world may refer to a simulated world in a single messenger based on an avatar profile or a character profile, and two panels including a real world and a virtual world in a messenger platform may exist. An inflow path of a virtual world may be fixed in a predetermined position, such as, a tab bar of a messenger.

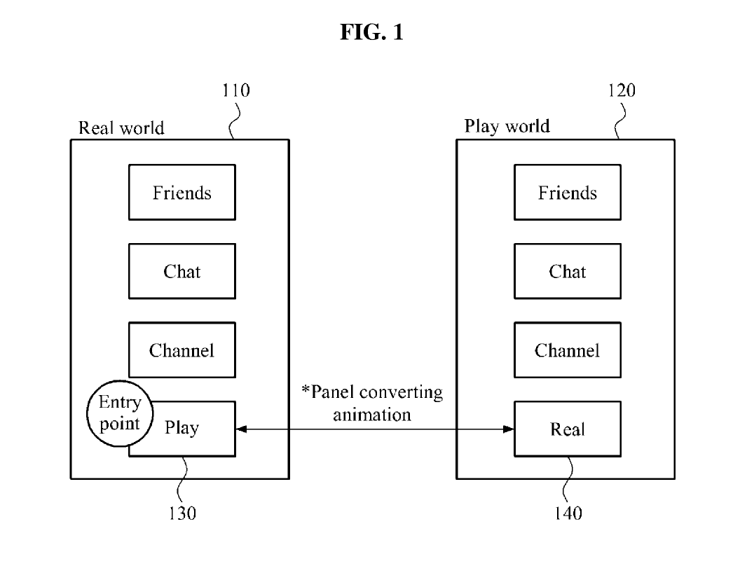

FIG. 1 illustrates two panels, a real world and a virtual world, according to exemplary embodiments of the present invention. The real world interface 110 of FIG. 1 may indicate the real world panel, and the play/virtual world interface 120 may indicate the virtual world panel. The play world 120 may provide an avatar, a room, a chat group, a shop, and the like. The play world 120 may provide a play channel including a game list, a timeline, a notification, and the like, in addition to a friend list, and the like. The play channel may indicate a social platform. The social platform can be a social aggregate of an internally/externally created application, also referred to as “App.” The social platform can be identical to a messenger channel. A service provided through the virtual world panel may usually be a game or a casual service based on an avatar profile.

The real world panel interface 110 can convert to the virtual world panel with an entry point, such as, “Play” 130, and the virtual world interface 120 can include an entry point for converting to the real world panel, such as, “Real” 140. A panel converting animation may be provided to a user when converting from a real world to a virtual world, or from the virtual world to the real world.

Service Point

According to exemplary embodiments of the present invention, various entertainment contents may be provided to users based on a social graph, for example, the real graph, and various devices for encouraging a revisit to a virtual world and for increasing duration of use based on a social network may be made available. For example, rewards like an item/experience/cash may be provided when a friend or an acquaintance is invited, and a more entertaining game may be provided by allowing a user to play a game with the friend. Devices for attracting a friend on a messenger to the virtual world may be arranged in necessary positions.

A social type game playable with a friend and a necessary platform may be provided. For example, information on new entertainment contents to be shared with the friend may be transferred to users virally, and a new type of feed with a hint of game may be provided.

A menu may be reconfigured in a form optimized to the virtual world. For example, menus may include an avatar, a room, a shop, chat, a game list, a game end, a timeline, a notification, a friends list, a search for friends, a friend recommendation, news, frequently asked questions (FAQ), and the like.

3A web App and a native App may be displayed strategically.

When a messenger friend of a user creates an avatar, the avatar may be registered as an avatar of the user automatically. In this instance, a definition of the avatar friend may be provided based on detailed definitions as to whether a counterpart is a mutual friend, which form a messenger friend to be added may take, whether the messenger friend may be registered automatically without a request/confirmation, whether a privacy setting of openly registering the messenger friend is provided, and the like.

Whether virtual world timeline data is based on a user, a service unit, or a game unit may be determined by the messenger. A case of admitting an external producing company may be considered on the whole. In addition, a data merging scheme for an instance in which a plurality of feeds of a single user are displayed as accumulated may be suggested.

A Process for Interoperating a Real World and a Virtual World

The process for interoperating the real world and the virtual world may refer to a service in a form enabling a user to utilize a single App through a messenger-based world or an avatar, gaming and entertainment-based world. The user may use services provided through each of the real world and the virtual world freely, by clicking or touching a user interface.

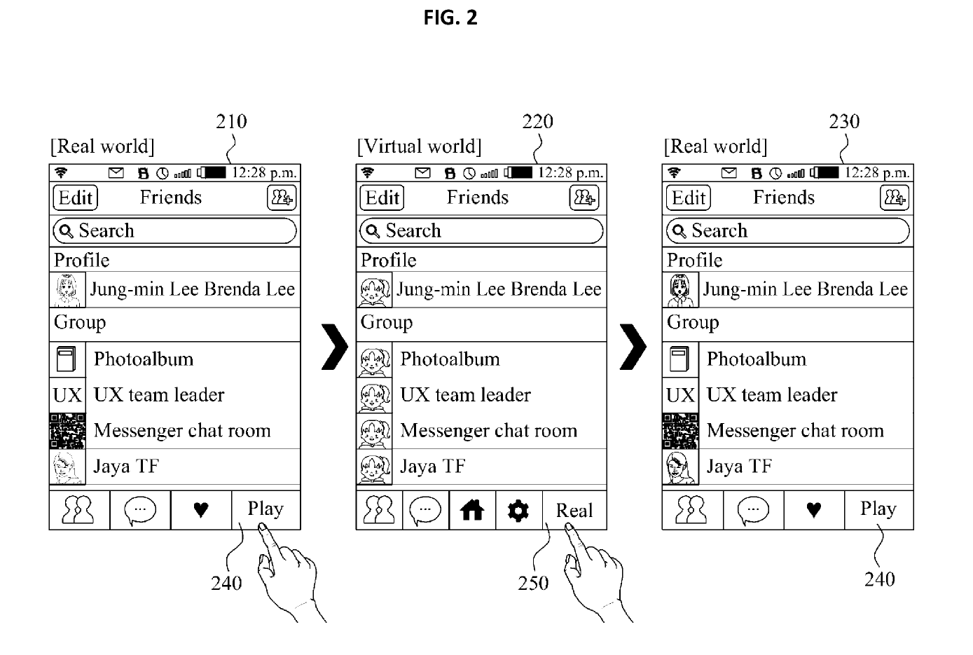

FIG. 2 illustrates a conversion between a real world and a virtual world according to exemplary embodiments of the present invention. FIG. 2 illustrates a terminal screen being converted from a real world panel 210 to a virtual world panel 220, and from the virtual world panel 220 to a real world panel 230. For example, each terminal screen can be provided by mobile devices, such as, a smart phone. The two worlds may be converted by clicking or touching a user interface such as a “Play” tab 240 or a “Real” tab 250.

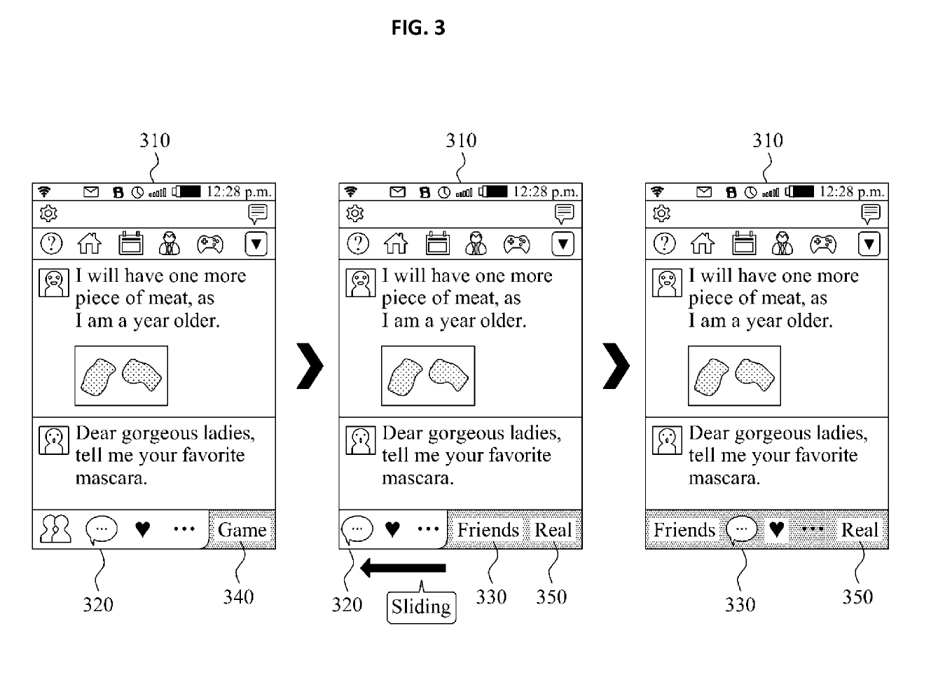

FIG. illustrates an avatar menu according to exemplary embodiments of the present invention. FIG. 3 illustrates a process in which a real world panel 310 provides a messenger tab bar 320 and an avatar menu 330 that can be hidden under the messenger tab bar 320. The avatar menu 330 can be unfolded by a sliding motion in response to a tab of a user on an avatar icon 340. A number of menus unfolded may be predetermined, and a total menu may be displayed. A background of the menus unfolded may be serviced through a corresponding screen being displayed in response to a click on a new menu on the bottom while maintaining an original screen. In this instance, various services provided in a virtual world such as an avatar, a game, and the like, may be included in the avatar menu 330.

When a real icon 350 is tapped by the user, the avatar menu 330 may disappear again, and the messenger tab bar 320 may reappear.

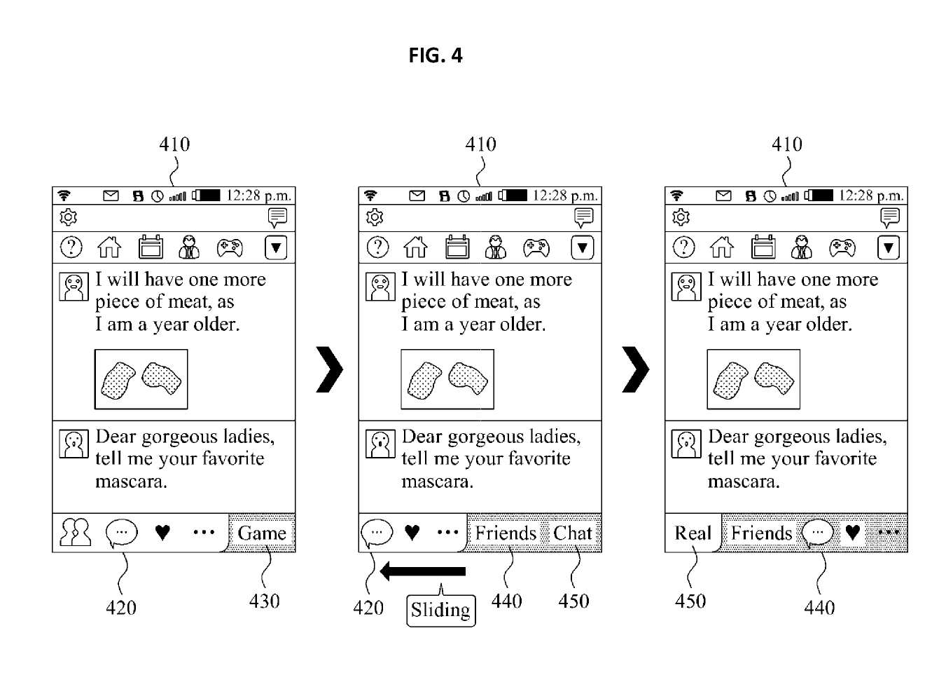

FIG. 4 illustrates an avatar menu according to exemplary embodiments of the present invention. FIG. 4 illustrates a process in which an avatar menu 440 is unfolded by a sliding motion in response to a tab of a user on an avatar icon 430 of a messenger tab bar 420 in a virtual world panel 410. FIG. 4 illustrates an example in which a position of a real icon 450 for returning to the original messenger tab bar 420 is changed when compared to the real icon 350 of FIG. 3. In particular, FIGS. 3 and 4 illustrate that a conversion between a real world and a virtual world may be possible through a user interface using a tab bar on a bottom, and illustrating that the user interface may be configured freely as necessary.

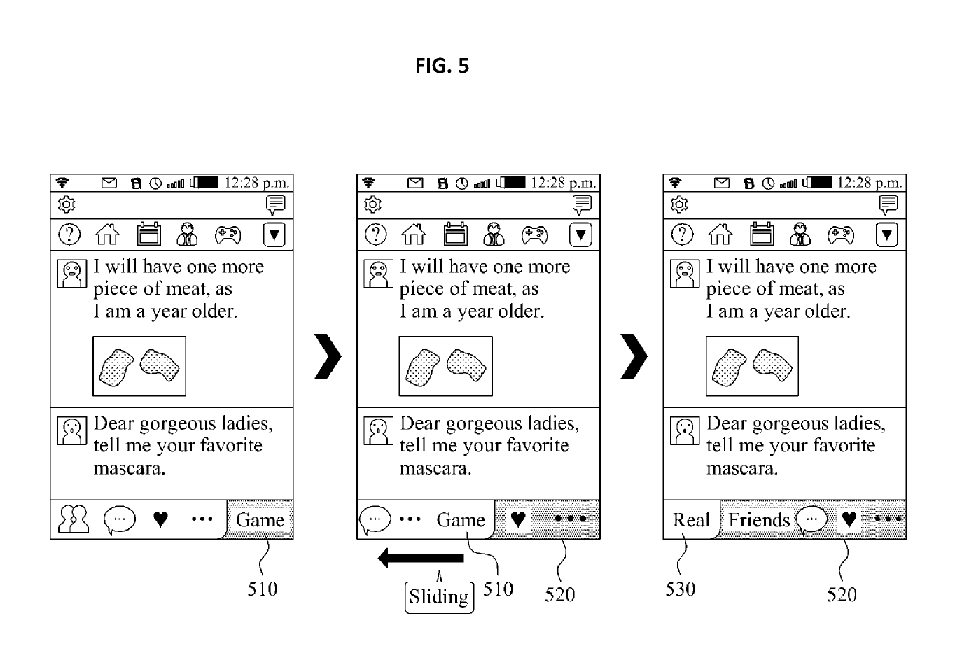

FIG. 5 illustrates an avatar menu according to exemplary embodiments of the present invention. FIG. 5 illustrates an avatar icon 510, being a tab, a user interface, for converting from a real world to a virtual world, slides with an avatar menu 520. In this instance, when the avatar menu 520 is unfolded entirely, the avatar icon 510 may be changed to a real icon 530.

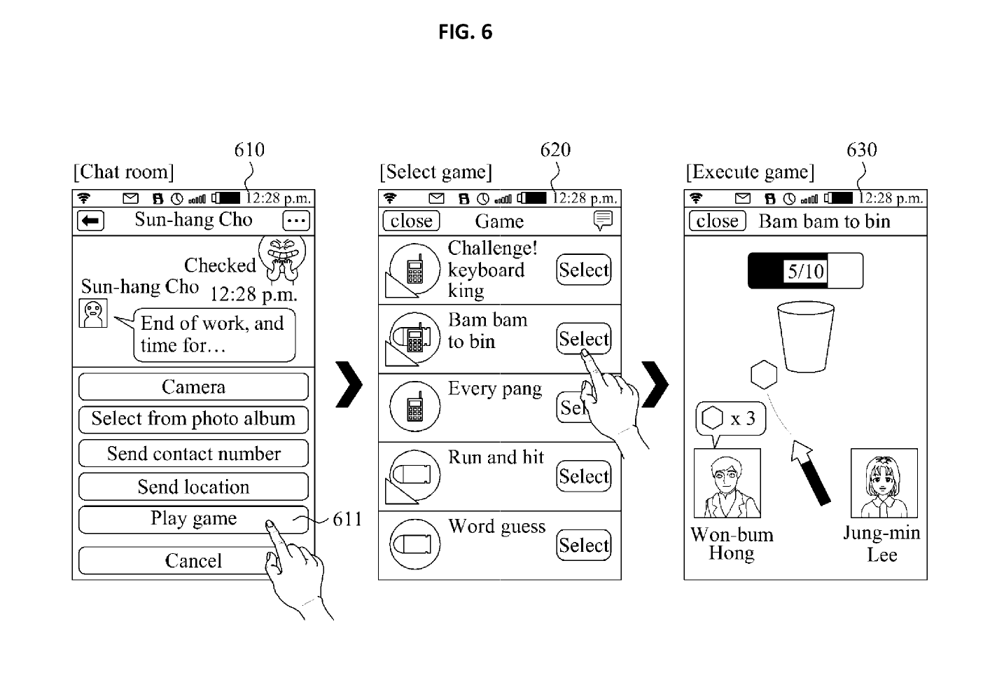

FIG. 6 illustrates a method for interacting with a game on a chat screen according to exemplary embodiments of the present invention. FIG. 6 illustrates a user interface provided with a game list on a chat screen directly. The user interface 611 for converting to a game selection screen 620 for selecting a game may be included in a chat room screen 610. A function for converting to the game selection screen 620 may be provided in a chat room. When a game is selected on the game selection screen 620 by a user, the game may proceed on a game execution screen 630. In this instance, the selected game may proceed simultaneously with another user chatting on a messenger.

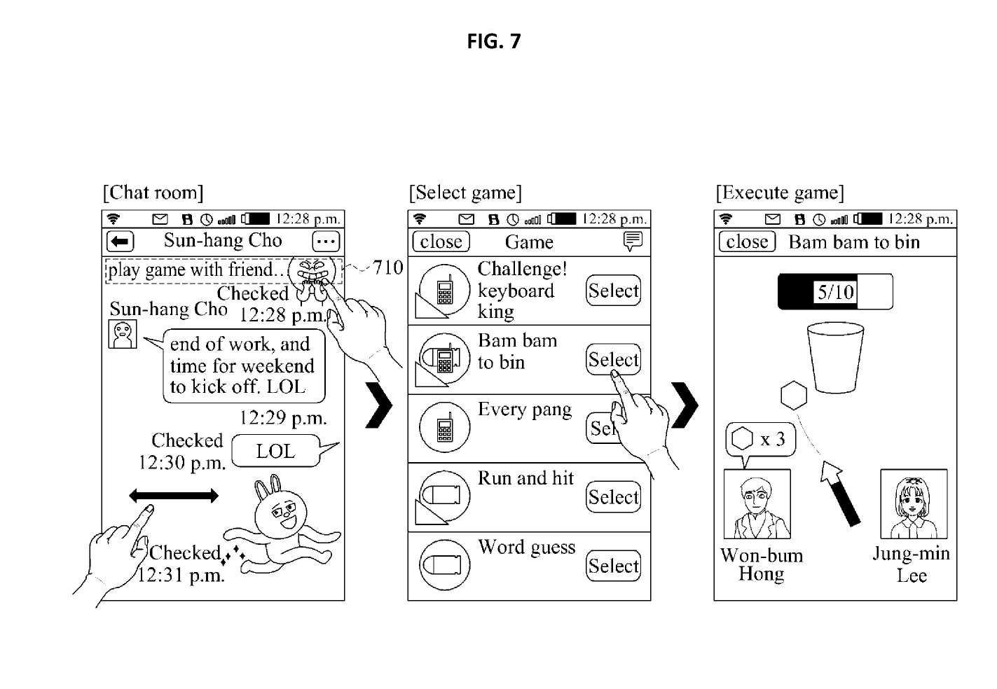

FIG. 7 illustrates a method for interacting with a game on a chat screen according to exemplary embodiments of the present invention. FIG. 7 illustrates a user interface 710 provided with a game list through a banner or a promotion area on a chat screen. When the user interface area shown in a dotted box is tapped by a user, the game list may be provided to the user as illustrated in FIG. 6.

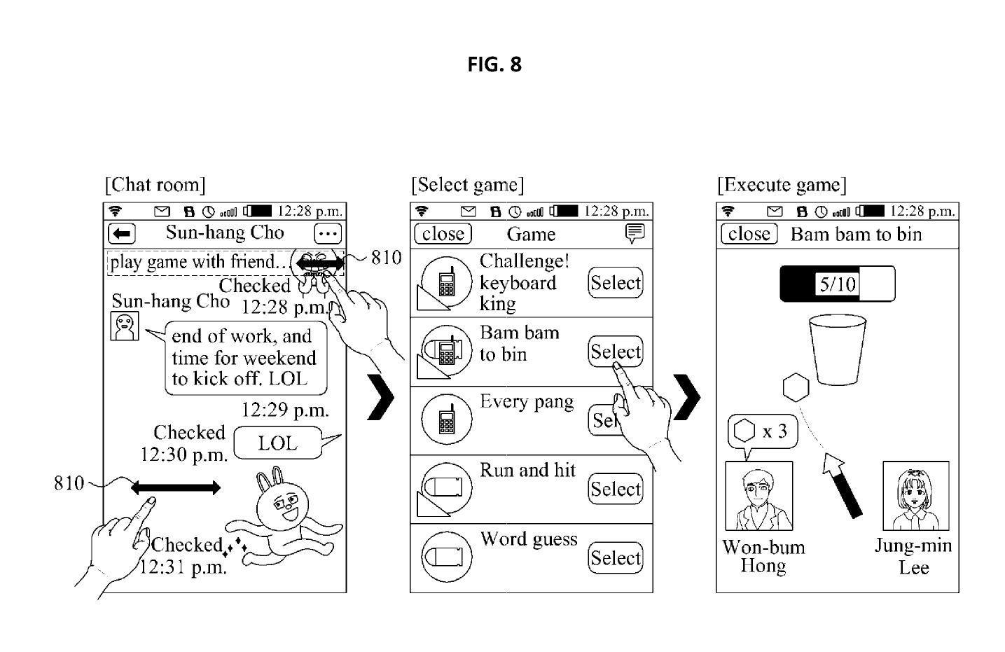

FIG. illustrates a method for interacting with a game on a chat screen according to exemplary embodiments of the present invention. FIG. 8 illustrates a user interface provided with a game list through a user event 810 such as clicking or flicking a banner on an upper portion of a chat screen or flicking the chat screen to right or left, and the like. An area shown in a dotted box in FIG. 8 may correspond to the banner on the upper portion of the chat screen.

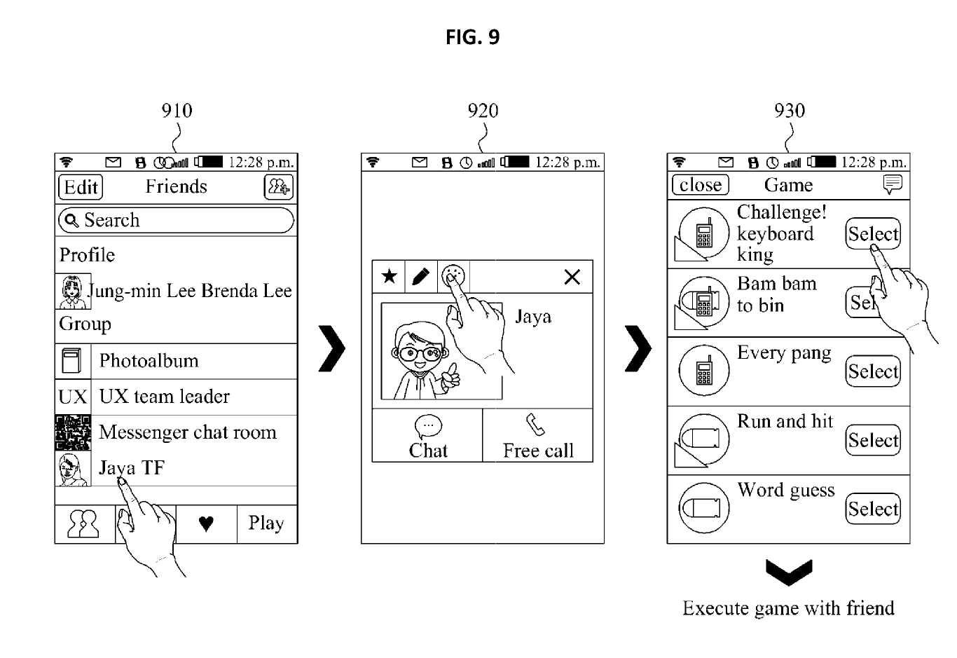

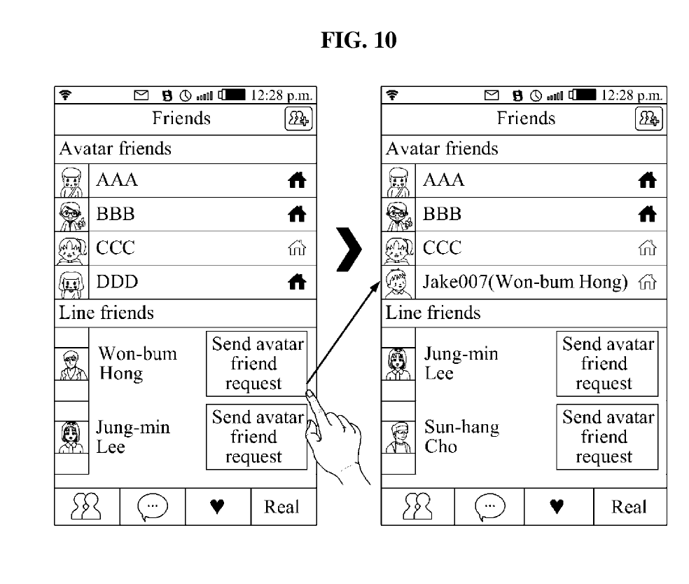

FIG. 9 illustrates a method for interacting with a game in a friend listing according to exemplary embodiments of the present invention. FIG. 9 illustrates a user interface for selecting a friend from a real graph, and selecting a game to play with the selected friend. A first screen 910 illustrates a messenger friends list, and a friend being selected. A second screen 920 illustrates information on the selected friend being displayed through a pop-up window on the messenger friends list, and the user interface for a game included in the pop-up window being selected. A third screen 930 illustrates a game list. For example, it is possible to play a game selected from the third screen 930 with a friend selected from the first screen 910.

FIG. 10 illustrates a method for interoperating a real graph of a messenger and a virtual graph of a virtual world according to exemplary embodiments of the present invention. A method for interoperating a real graph of a messenger and a virtual graph in a virtual world may include a friend recommendation scheme that displays active acquaintances or inactive acquaintances in a virtual world from among acquaintances with which a user establishes a relationship on a messenger to a friend's recommendation list. The method provides a service of making a friend request directly to another user with whom the user desires to be virtual friends with by including in the virtual graph acquaintances from among the acquaintances displayed on the friends recommendation list, and a scheme for making a friend automatically in which acquaintances active in a virtual world from among acquaintances with whom a user establishes a relationship on a messenger are automatically set to be acquaintances in the virtual world. A relationship is displayable using a virtual graph. FIG. 10 illustrates a user interface for providing a friends list on a messenger, and for setting a friend selected by a user to be an avatar friend.

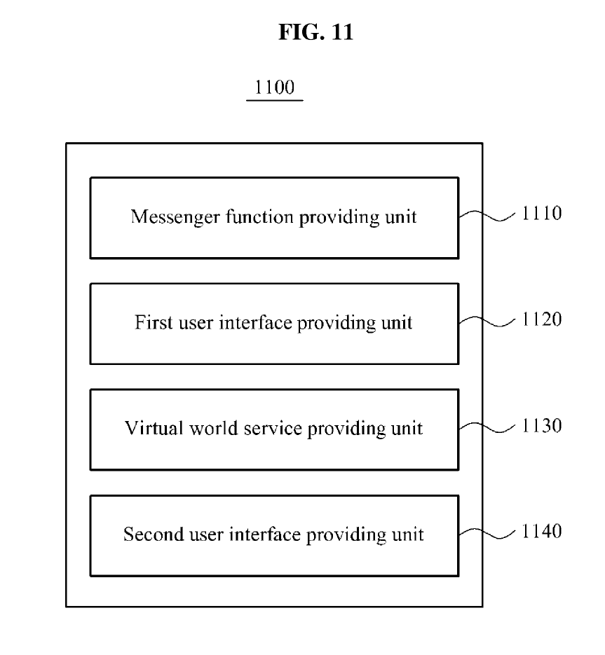

FIG. 11 illustrates an inner configuration of a messenger system according to exemplary embodiments of the present invention. The messenger system 1100 may indicate a system for providing a messenger service using a real graph displaying social information of users using a messenger, and may include a messenger function providing unit 1110, a first user interface providing unit 1120, a virtual world service providing unit 1130, and a second user interface providing unit 1140 as shown in FIG. 11.

The messenger function providing unit 1110 may provide a messenger function interactively associated with users between whom a relationship is established. The messenger function may provide general functions, such as, chatting, transmitting data, and the like, among users between whom a relationship is established. For example, the messenger system 1110 may store social information of users between whom a relationship is established through a database. When a first user wants to chat with a second user, the messenger system 1110 may support chatting between the first user and the second user by connecting the first user and the second user using the messenger function.

The first user interface providing unit 1120 may provide a first user interface for providing a virtual world service through the messenger function. The virtual world service may include at least one of an avatar service and a game service. The virtual world service may be provided based on a messenger platform providing a real world service. The first user interface providing unit 1120 may provide a link to the game service or avatar service through a messenger, and may also be able to provide the real world service, a messenger service, through the messenger platform and the virtual world service, such as, a avatar, gaming and entertainment service, by converting between the real world service and the virtual world service.

The virtual world service providing unit 1130 may provide the virtual world service using a virtual graph displaying social information of users using the virtual world service in response to a request through the first user interface, and provide the real world messenger service by converting the real world service to the virtual world service. The first user interface may be provided through the real world, and when a request from a user occurs through the first user interface, the virtual world service providing unit 1130 may provide the virtual world service by converting the real world request to the virtual world based on the messenger platform.

The first user interface may be set in at least one portion of a chat screen provided based on a messenger function. The request through the first user interface may occur when a predetermined user event generated in the at least one portion of the chat screen occurs. The at least one portion of the chat screen is described, for example, in the preceding with reference to FIGS. 7 and 8.

For example, the virtual world service providing unit 1130 may provide a service selection function for selecting a virtual world service to the user through the first user interface, and provide a selected service through the service selection function interactively to at least one other user chatting with the user through the messenger function. When the user selects a game, the virtual world service providing unit 1130 may provide a service such that the at least one other user chatting with the user may play the game with the user.

The first user interface may be provided interactively to at least one other user selected by a user from among users displayed on a real graph with which the user establishes a relationship. In this instance, the virtual world service providing unit 1130 may provide the service selection function for selecting a virtual world service to the user in response to a request through the first user interface, and provide a selected service through the service selection function interactively to the user and the at least one other user. When the user selects another user to play a game directly, and selects a game to play with the other user, the virtual world service providing unit 1130 may provide the user with a service to play the selected game with the other user selected.

The virtual world service providing unit 1130 may provide menu entries used in the virtual world service through a real world service, and provide the virtual world service based on a menu entry selected from among the menu entries. For example, an entry for identifying a friends list of the virtual world, an entry for identifying a game channel list, an entry for chatting on the game, and the like, may be provided through the real world service rather than the virtual world. The user may access an entry in the real world from among various menu entries with respect to a service of the virtual world using the menu entries.

The second user interface providing unit 1140 may provide a second user interface for converting the virtual world service to the real world service through the virtual world service. The messenger system 1100 may provide all services through the messenger platform in order to be used by converting between the real world service and the virtual world service. Accordingly, a user interface for converting from a virtual world to a real world is provided, and the second user interface may be provided to a user through the virtual world. For example, during provision of the virtual world service, the messenger function providing unit 1110 may provide the messenger function by converting the virtual world service to the real world service in response to a request from the second user interface.

The messenger system 1100 may further include a user recommendation unit (not shown) for recommending a user to be added in the virtual graph, using the real graph.

For example, the user recommendation unit may provide a list of users with whom a user establishes a relationship in the real graph, and may add at least one other user selected by the user interactively associated with the user to the virtual graph. In particular, a messenger friend of the user may be recommended as a virtual world friend, and a friend selected by the user from among the recommended friends may be added to the virtual world.

The user recommendation unit may identify another user using the virtual world service among users with whom a user establishes a relationship, and add the other user identified to the virtual graph interactively associated with the user. Friends using the virtual world service among messenger friends of the user may be added as virtual world friends automatically or without further requesting further input from the user.

FIG. illustrates a method for providing a messenger service according to exemplary embodiments of the present invention. The method for providing the messenger service may be conducted by the messenger system 1100 of FIG. 11.

In operation 1210, the method may provide a messenger function among users between whom a relationship is established. The messenger function may provide general functions such as chatting, transmitting data, and the like, among users between whom a relationship is established. For example, the messenger system 1100 may store social information of users between whom a relationship is established through a database, and when a first user wants to chat with a second user, the messenger system 1100 may support chatting between the first user and the second user by connecting the first user and the second user, using the messenger function.

In operation 1220, the method may provide a first user interface for providing a virtual world service through the messenger function. The virtual world service may include at least one of an avatar service and a game service. In this instance, the virtual world service may be provided based on a messenger platform providing a real world service. The first user interface providing unit 1120 may provide a link to the game service or avatar service through a messenger, and may also provide the real world messenger service through the messenger platform and the virtual world service, such as, an avatar, gaming and entertainment functions by converting the real world service and the virtual world service.

In operation 1230, the method may provide the virtual world service using a virtual graph displaying social information of users using the virtual world service in response to a request through the first user interface, and provide the real world service, the messenger service, by converting the real world service to the virtual world service. The first user interface may be provided through the real world, and when a request from a user occurs through the first user interface, the messenger system 1100 may provide the virtual world service by converting the real world to the virtual world based on the messenger platform.

The first user interface may be included in a portion of a chat screen of a messenger. The request through the first user interface may occur when a predetermined user event generated in the at least one portion of the chat screen occurs. The portion of the chat screen is exemplified in FIGS. 7 and 8.

In operation 1230, the method may provide a service selection function for selecting a virtual world service to the user in response to the request through the first user interface, and provide a selected service through the service selection function interactively to at least one other user chatting with the user through the messenger function. For example, when the user selects a game, the virtual world service providing unit 1130 may provide a service such that the at least one other user chatting with the user may play the game with the user.

the first user interface may be provided interactively to at least one other user selected by a user from among users displayed on a real graph with whom the user establishes a relationship the messenger system 1100 may provide the service selection function for selecting a virtual world service to the user in response to a request through the first user interface, and provide a selected service through the service selection function interactively to the user and the at least one other user. When the user selects another user to play a game directly and selects a game to play with the other user, the messenger system 1100 may provide the user with a service to play the selected game with the other user selected.

The method may provide menu entries used in the virtual world service through a real world service, and provide the virtual world service based on a menu entry selected from among the menu entries. For example, an entry for identifying a friends list of the virtual world, an entry for identifying a game channel list, an entry for chatting on the game, and the like, may be provided through the real world service rather than the virtual world. In particular, the user may access an entry in the real world from among various menu entries with respect to a predetermined service of the virtual world using the menu entries.

In operation 1240, the method may provide a second user interface for converting the virtual world service to the real world service through the virtual world service. The method may provide all services through the messenger platform in order to be used by converting between the real world service and the virtual world service. Accordingly, a user interface for converting from a virtual world to a real world is provided, and the second user interface may be provided to a user through the virtual world. For example, during provision of the virtual world service, the method for providing the messenger service may include providing of the messenger function by converting the virtual world service to the real world service in response to a request from the second user interface.

The method for providing the messenger service may include recommending of a user (not shown) to recommend a user to be added in the virtual graph, using the real graph. For example, the method may provide a list of users with whom a user establishes a relationship in the real graph to recommend another user, and may add at least one other user selected by the user interactively associated with the user to the virtual graph. A messenger friend of the user may be recommended as a virtual world friend, and a friend selected by the user from among the recommended friends may be added to the virtual world.

The method may identify another user using the virtual world service among users with whom a user establishes a relationship, and add the other user identified to the virtual graph interactively associated with the user. Friends using the virtual world service among messenger friends of the user may be added as virtual world friends automatically or without further user interaction.

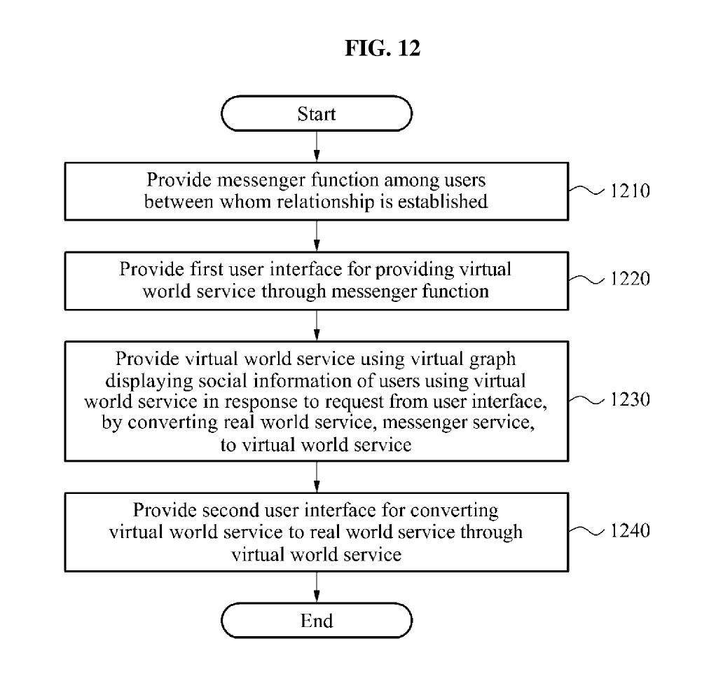

For any descriptions omitted in FIGS. 11 and 12, reference may be made to FIGS. 1 to 10.

According to exemplary embodiments of the present invention, it is possible to provide avatar, gaming and entertainment functions on a messenger platform.

According to exemplary embodiments of the present invention, it is possible to provide a real world service such as a messenger service and a virtual world service such as an avatar service and a game service.

According to exemplary embodiments of the present invention, it is possible to provide a real world service and a virtual world service by converting a real world based on a real graph displaying social information on a messenger and a virtual world based on a virtual graph.

According to exemplary embodiments of the present invention, it is possible to recommend a user for establishing a relationship in a virtual world using a real graph on which a real world is based.

The method for providing the messenger service may further include providing the virtual world service by converting the virtual world service to the real world service in response to a request from the second user interface.

The providing of the virtual world service by converting the real world service, the messenger service, to the virtual world service may include providing a service selection function for selecting a virtual world service to a user in response to the request from the first user interface, and providing the service selected through the service selection function interactively to the user and at least one other user chatting with the user through the messenger function.

The method for providing the messenger service may further include recommending a user to be added to the virtual graph, using the real graph.

The recommending of the user may include providing a list of users displayed on the real graph with which a user establishes a relationship, and adding at least one other user selected by the user to the virtual graph interactively associated with the user.

The recommending of the user may include identifying another user using the virtual world service among the users displayed on the real graph with which the user establishes a relationship, and adding the other user to the virtual graph interactively associated with the user.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM discs and DVD; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method that uses a processor to perform a messenger service using a real graph displaying social information of users using a messenger, the method comprising:
providing a messenger function to users between whom a relationship is established using the messenger;
providing a first user interface for providing a virtual world service through the messenger function;
converting, using the processor, a real world messenger service to the virtual world service in response to a request from the first user interface;
providing the virtual world service using a virtual graph displaying social information of users using the virtual world service; and
providing a second user interface for converting the virtual world service to the real world service through the virtual world service,
wherein the virtual world service comprises at least one of an avatar service and a game service.

2. The method of claim 1, wherein the virtual world service is based on a messenger platform providing the real world service.

3. The method of claim 1, further comprising:
converting the virtual world service to the real world service in response to a request from the second user interface.

4. The method of claim 1, wherein the converting the real world messenger service to the virtual world service comprises:
providing a service selection function for selecting a virtual world service to a user in response to the request from the first user interface, and providing the service selected through the service selection function interactively to the user and at least one other user chatting with the user through the messenger function.

5. The method of claim 1, wherein the first user interface is provided interactively to at least one other user selected by the user among the users displayed on the real graph, and
the converting the real world messenger service, to the virtual world service comprises providing a service selection function of selecting one of virtual world services to the user, and providing a service selected through the service selection function interactively to the user and the at least one other user.

6. The method of claim 1, further comprising:
recommending a user to be added to the virtual graph, using the real graph.

7. The method of claim 6, wherein the recommending of the user comprises:
providing a list of users displayed on the real graph, and adding at least one other user associated with the user to the virtual graph interactively.

8. The method of claim 6, wherein the recommending of the user comprises:
identifying another user using the virtual world service among the users displayed on the real graph, and adding the other user to the virtual graph interactively associated with the user.

9. The method of claim 1, wherein the providing of the virtual world service comprises:
providing menu entries used in the virtual world service through the real world service, and providing a virtual world service based on a menu entry selected from among the menu entries.

10. The method of claim 1, wherein the first user interface is set in a portion of a chat screen based on the messenger function, and
the request from the first user interface occurs when a user event generated in the portion of the chat screen is detected.

11. A messenger system for providing a messenger service using a real graph displaying social information of users using a messenger, the messenger system comprising:
a processor;
a messenger function providing unit configured to provide a messenger function interactively to users between whom a relationship is established among the users;
a first user interface configured to provide a virtual world service through the messenger function;
a virtual world service providing unit to provide the virtual world service by converting, using the processor, a real world service to the virtual world service, wherein the virtual world service provided using a virtual graph displaying social information of users using the virtual world service in response to a request from the first user interface; and
a second user interface configured to convert the virtual world service to the real world service, through the virtual world service,
wherein the virtual world service comprises at least one of an avatar service and a game service.

12. The messenger system of claim 11, wherein the virtual world service is based on a messenger platform providing the real world service.

13. The messenger system of claim 11, wherein the messenger function providing unit further comprises converts the virtual world service to the real world service, in response to a request from the second user interface during provisioning of the virtual world service.

14. The messenger system of claim 11, wherein the virtual world service providing unit further comprises a service selection function for selecting a virtual world service by a user in a response to the request from the first user interface, and provides a service selected by the service selection function interactively to the user and at least one other user chatting with the user through the messenger function.

15. The messenger system of claim 11, wherein the first user interface is provided to at least one other user selected by the user among the users displayed on the real graph with whom the user establishes a relationship, and
the virtual world service providing unit further comprises a service selection function for selecting a virtual world service to the user in response to the request from the first user interface, and provides a service selected by the service selection function interactively to the user and the at least one other user selected.

16. The messenger system of claim 11, further comprising:
a user recommendation unit to recommend a user to be added to the virtual graph using the real graph.

17. The messenger system of claim 11, wherein the virtual world service providing unit further comprises menu entries used in the virtual world service through the real world service, and a virtual world service based on a menu entry selected from among the menu entries.

18. The messenger system of claim 11, wherein the first user interface further comprises a portion of a chat screen being provided based on the messenger function, and
the request from the first user interface occurs when a user event generated in the portion of the chat screen is detected.

19. A non-transitory computer-readable recording medium comprising a program for storing instructions for a computer system to provide a messenger service using a real graph displaying social information of users using a messenger, which when executed performs the following steps:
providing a messenger function interactively to users between whom a relationship is established;
providing a first user interface for providing a virtual world service through the messenger function;
converting a real world messenger service to the virtual world service in response to a request from the first user interface;
providing the virtual world service using a virtual graph displaying social information of users using the virtual world service;
providing a second user interface for converting the virtual world service to the real world service through the virtual world service; and
controlling the computer system providing the virtual world service, wherein the virtual world service comprises at least one of an avatar service and a game service.

20. The non-transitory computer-readable recording medium of claim 19, wherein the method further comprises:
providing the real world service by converting the virtual world service to the real world service in response to a request from the second user interface.

21. A method that uses a processor to perform a messenger service using a real graph displaying social information of users using a messenger, the method comprising:
providing a messenger friends list to a user, or providing a function of chatting with friends with whom the user establishes a relationship, using the real graph;
providing a user interface for providing a game service list through the messenger friends list or the function of chatting;
providing the game service list in response to a request from the user interface, and
playing, using the processor, a game selected from the game service list interactively with a selected chatting friend or with a friend selected from the messenger friends list.

22. The method of claim 21, wherein at least one of the game services included in the game service list is provided using a virtual graph displaying social information of users using the at least one of the game services.

23. The method of claim 22, wherein a messenger friend registered in the real graph of the user is registered in the virtual graph automatically.

24. The method of claim 22, further comprising:
providing, to the user, a user interface for adding another user, with whom the user establishes a relationship to the virtual graph, using the real graph.

25. A method that uses a processor to perform an interworking service, the method comprising:
providing a real graph displaying social information of users using a messenger service providing a function of chatting; and
displaying, using the processor, a virtual graph of social information of users using a game service,
wherein the virtual graph is set using information provided by the real graph.

26. The method of claim 25, wherein a messenger friend registered in the real graph of the user is registered in the virtual graph automatically.

27. The method of claim 25, further comprising:
comparing the real graph and the virtual graph; and
providing, to the user, a user interface for adding another user with whom a relationship is yet to be established with the user, to the virtual graph from among users displayed on the real graph with whom the user of the messenger service establishes a relationship.

28. The method of claim 25, further comprising:
providing a messenger friends list to a user, or providing a function of chatting with a friend with whom the user establishes a relationship, using the real graph;
providing a user interface for providing the messenger friends list or a game service list through the function of chatting;
providing the game service list in response to a request from the user interface; and
playing a game selected from the game service list interactively with a selected chatting friend or with a friend selected from the messenger friends list.

29. A messenger system for providing a messenger service using a real graph displaying social information of users using a messenger, the messenger system comprising:
a messenger function providing unit configured to provide a messenger friends list to a user using the real graph, or to provide a function of chatting with a friend with whom the user establishes a relationship;
a first user interface configured to provide a game service list through the messenger friends list or the function of chatting; and
a service providing unit configured to provide the game service list in response to a request from the first user interface, and to provide a game selected from the game service list interactively by a user and a chatting friend, or by the user and a friend selected from the messenger friends list.

30. The messenger system of claim 29, wherein at least one of the game services included in the game service list is provided using a virtual graph displaying social information of users using the at least one of the game services.

31. The messenger system of claim 30, wherein a messenger friend registered in the real graph of the user is registered in the virtual graph automatically.

32. The messenger system of claim 30, further comprising:
a user interface configured to add another user with whom the user establishes a relationship to the virtual graph, using the real graph.

33. A messenger system comprising:
a real graph providing unit configured to provide a real graph displaying social information of users using a messenger service providing a function of chatting; and
a virtual graph providing unit configured to provide a virtual graph displaying social information of users using a game service,
wherein the virtual graph is set using the real graph.

34. The messenger system of claim 33, wherein a messenger friend registered in the real graph of the user is registered in the virtual graph automatically.

35. The messenger system of claim 33, further comprising:
a comparing unit configured to compare the real graph to the virtual graph; and
a user interface configured to add another user with whom a relationship is yet to be established with the user to the virtual graph from among users displayed on the real graph with whom the user of the messenger service establishes a relationship.

36. The messenger system of claim 33, further comprising:
a messenger function providing unit configured to provide a messenger friends list to a user using the real graph, or to provide a function of chatting with a friend with whom the user establishes a relationship;
a user interface configured to provide the messenger friends list or a game service list through the function of chatting; and
a game providing unit configured to provide the game service list in response to a request from the user interface, and to provide a game selected from the game service list interactively to a selected chatting friend, or a friend selected from the messenger friends list.
